(19) United States
(12) Patent Application Publication
(10) Pub. No.: US 2003/0141234 A1
(43) Pub. Date: Jul. 31, 2003

(54) Water treatment device

(76) Inventor: Yi-Yu Chien, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/058,909

(22) Filed: Jan. 30, 2002

(51) Int. Cl. C02F 1/48

(52) U.S. Cl. 210/223; 210/259; 210/502.1

(57) ABSTRACT

A water treatment device includes four filtering members connected in series and the filtering members include a porous film, an active carbon, a ceramic tank or magnets and porous objects. The magnets activate the water and the mineral substances can be solved in the water.

### FIELD OF THE INVENTION

The present invention relates to a water treatment device comprising four different filtering members to maintain mineral substances in the water and activate the water.

### BACKGROUND OF THE INVENTION

A conventional water treatment device generally includes at least one filter which has a porous film so as to stop particles in the water when water flows through the filter. However, there are so many different types of particles existed in the water and we need only few of them such as mineral substances. A film that has extraordinary small holes is used to prevent all the particles going through the film so as to obtain a pure water which almost has no any mineral substance therein, This way is used in labs to make pure water which is not suitable for edible water. Distilling is another way to get water and takes a long period of time which is not satisfied by the users who want to have enough quantity of water when they need.

### SUMMARY OF THE INVENTION

In accordance with one aspect of the present invention, there is provided a water treatment device comprising a first filtering member a porous film received therein and connected to a second filtering member which has active carbon received therein. The second filtering member is connected to a third filtering member in which a high density ceramic tank is received. The third filtering member is connected to a fourth filtering member in which a plurality of cylinders are received and each cylinder is filled with porous pebbles enclosed by magnets.

The primary object of the present invention is to provide a water treatment device that activates the water by magnets and maintain mineral substances in the water.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a plane view to show the arrangement of parts of the water treatment device of the present invention;

FIG. 2 is a cross sectional view to show the first filtering member of the water treatment device of the present invention;

FIG. 3 is a cross sectional view to show the second filtering member of the water treatment device of the present invention;

FIG. 4 is a cross sectional view to show the third filtering member of the water treatment device of the present invention;

FIG. 5 is an exploded view to show the fourth filtering member of the water treatment device of the present invention;

FIG. 6 is an exploded view to show the cylinder in the fourth filtering member of the water treatment device of the present invention;

FIG. 7 is a top view to show the cylinder in the fourth filtering member of the water treatment device of the present invention;

FIG. 8 is a cross sectional view to show the fourth filtering member of the water treatment device of the present invention;

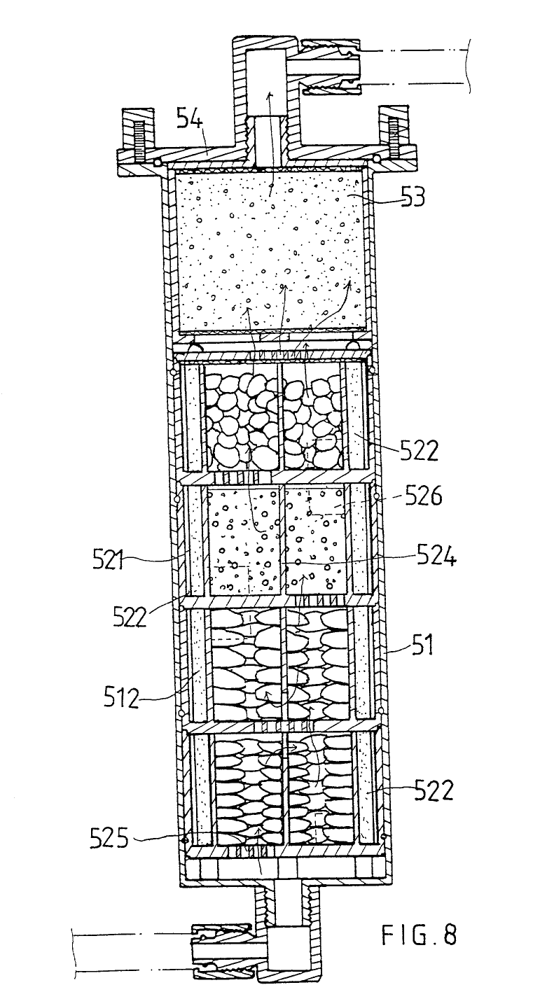

FIG. 9 shows the sequence of water flowing through the filtering members of the water treatment device of the present invention, and

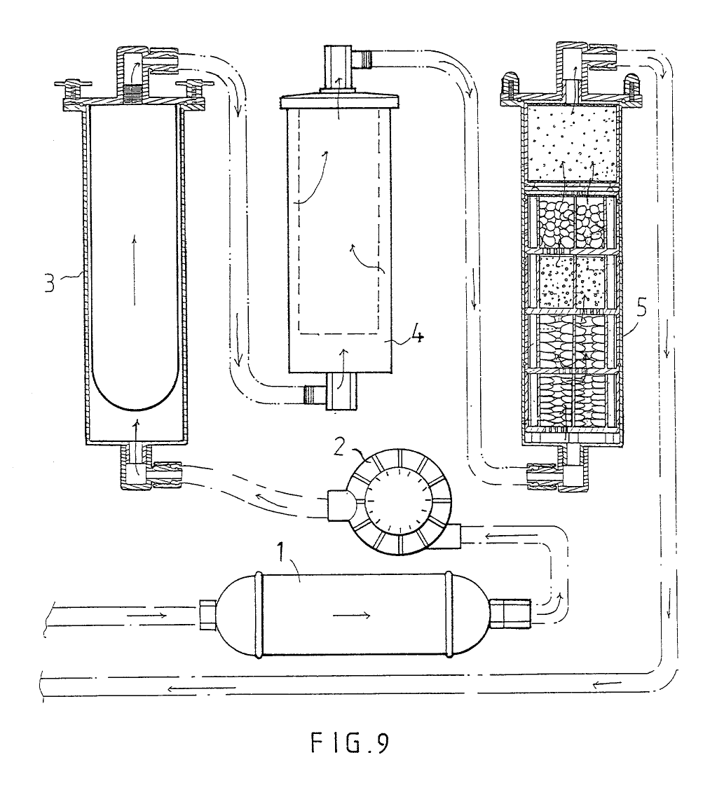

FIG. 10 shows different arrangements of the magnets in the cylinders in the fourth filtering member of the water treatment device of the present invention.

### DETAILED DESCRIPTION OF THE PREFERRED EMBODIMENT

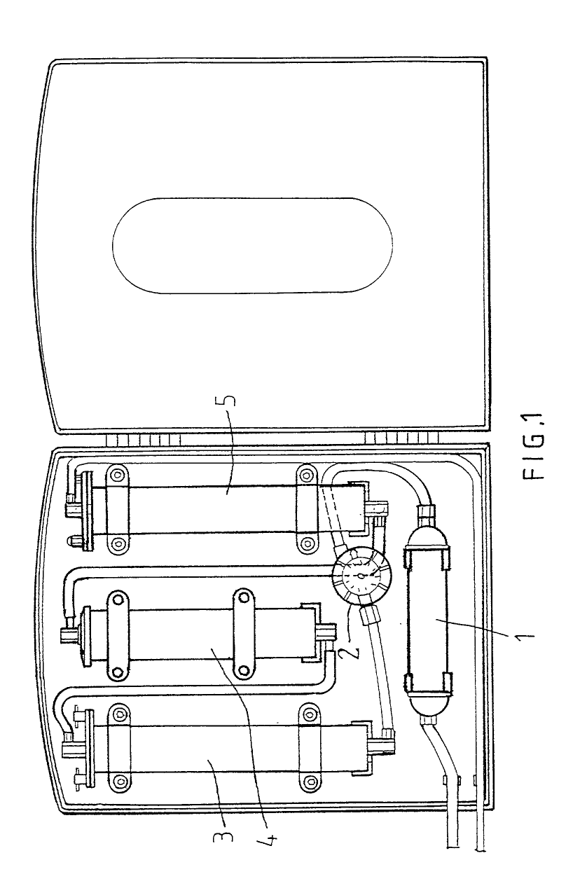

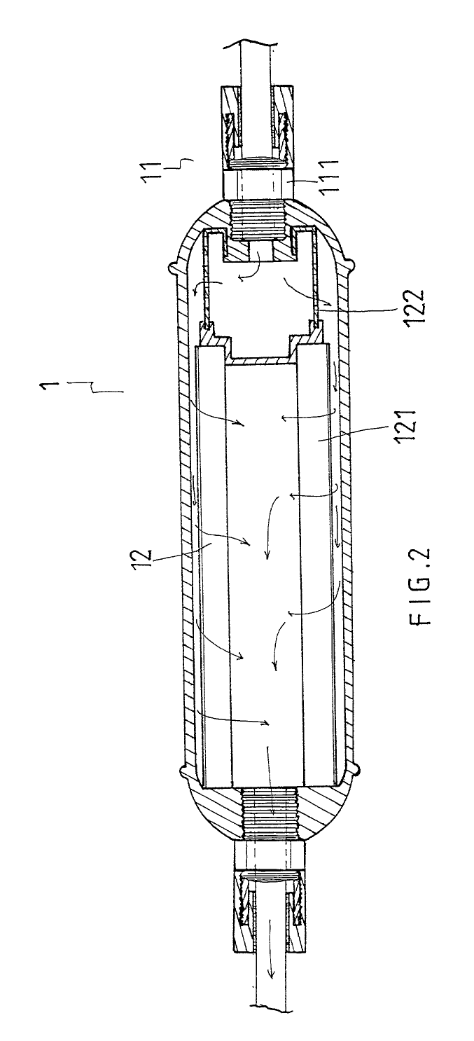

Referring to FIGS. 1 and 2, the water treatment device of the present invention comprises casing in which a first filtering member 1, a second filtering member 3, a third filtering member 4, and a fourth filtering member 5. A first end 11 of the first filtering member 1 has a fitting 111 which is connected to an inlet pipe and a second end of the first filtering member 1 is connected to water gauge 2. An inner tube 12 is received in the first filtering member 1 and has a plurality of holes 121 defined therethrough. A porous film 122 is connected to the first end 11 of the first filtering member 1.

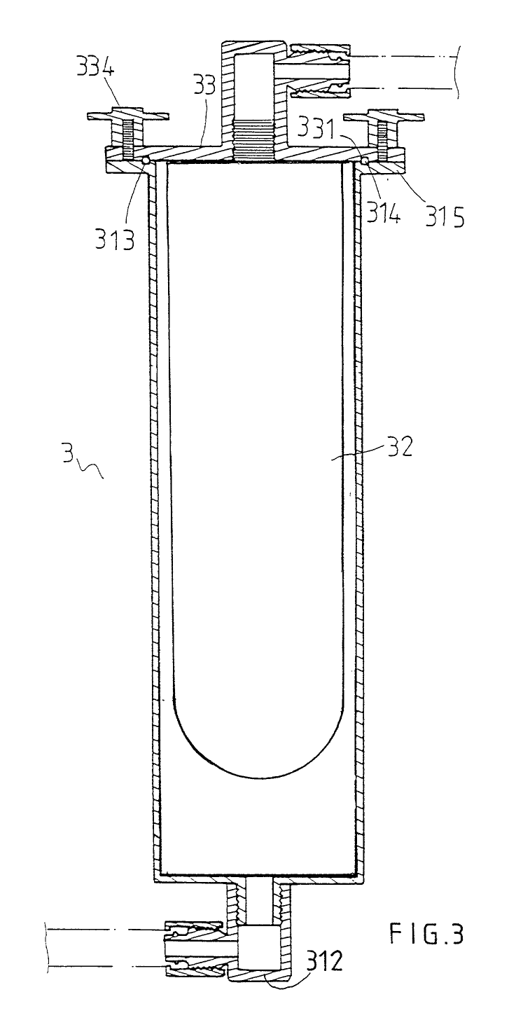

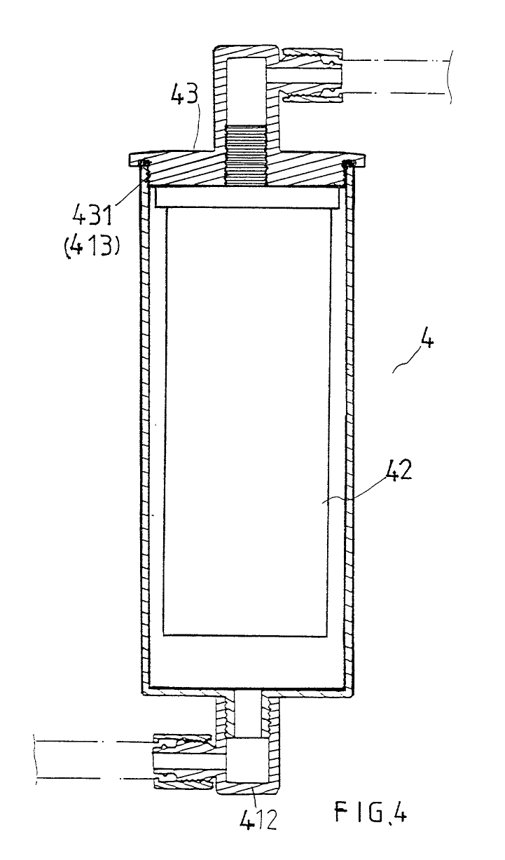

As shown in FIG. 3, a first end 312 of the second filtering member 3 is connected to the water gauge 2 via the inlet pipe and a second end of the second filtering member 3 is connected to a first end 412 of a third filtering member 4 as shown in FIG. 4. A high density ceramic tank 32 is received in the second filtering member 3 and communicates with the second end of the second filtering member 3. The ceramic tank 32 has even smaller holes than the inner tube 12 and the porous film 122 so as to prevent smaller particles in the water from passing through the ceramic tank 32. A cap 33 is connected to the second end of the second filtering member 3 and a flange 315 extends radially from the second end of the second filtering member 3. A seal 314 is received in two respective grooves 313, 331 in the cap 33 and the lugs 315. The cap 33 is secured to the second end of the second filtering member 3 by threading means 334.

Referring to FIG. 4, a second end of the third filtering member 4 is connected to a first end of a fourth filtering member 5, and a second end of the fourth filter member 5 is connected to the outlet pipe. An active carbon cell 42 is received in the third filtering member 4 and communicates with the second end of the third filtering member 4. A cap 43 is connected to the second end of the third filtering member 4 by threads 431/413 defined in the cap 43 and the third filtering member 4.

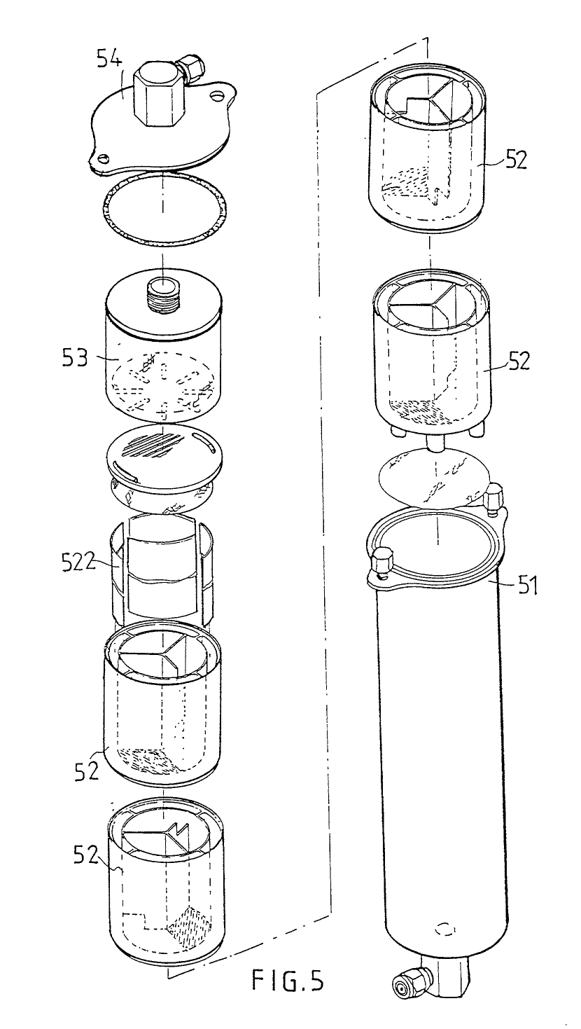

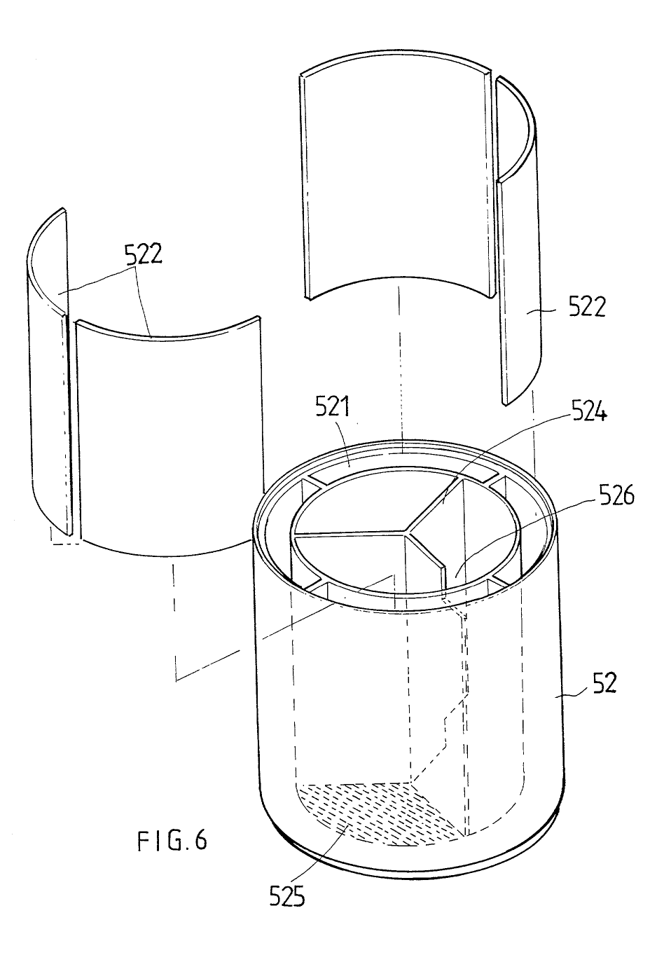

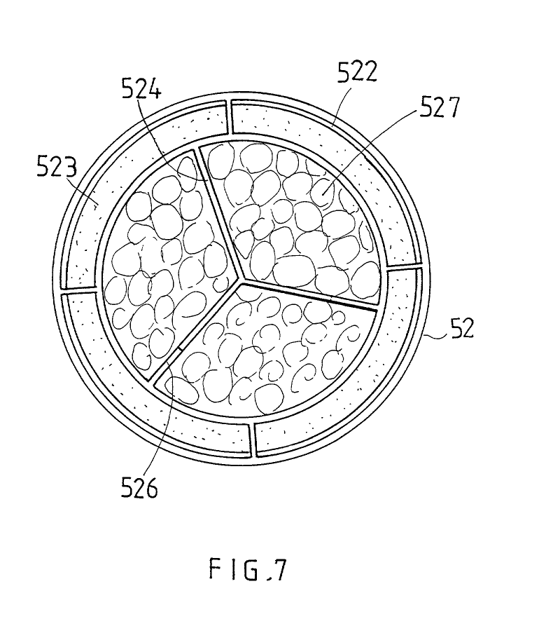

Referring to FIGS. 5, 6 and 7, the fourth filtering member 5 has a plurality of cylinders 52 received in the body 51 thereof and arranged to be overlapped along an axis of the fourth filtering member 5. Each cylinder 52 has a tube received therein and a plurality of ribs extend from an inside of the cylinder 52 to be connected to the tube. A plurality of chambers 521 are defined between the inside of the cylinder 52 and the tube. Each chamber 521 has a magnet 523 received therein and each chamber 521 receive a plate 522 which is used to prevent the magnetic feature form escaping. A plurality of separation flanges 524 are in each tube so as to define a plurality of chambers in each of the tubes. One of the separation flanges 524 has two notches 526 to allow water to flow therethrough. Each tube has a close bottom which has apertures 525 defined therethrough and the chambers are filled with variety types of porous pebbles 527. A water tank 53 is put on the top of the pile of the cylinders 52 and a top cap 54 is connected to the second end of the fourth filtering member 5.

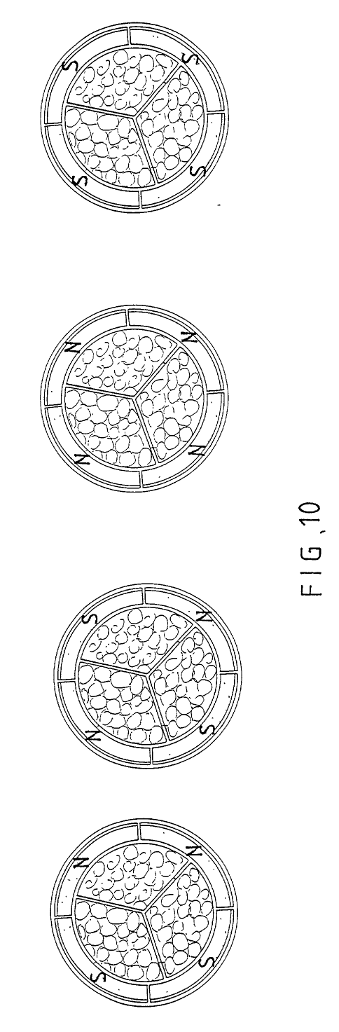

The water gauge 2 tells the user when the active carbon is to be replaced and the water flow is indicated by arrow heads. The arrangement of poles of the magnets 523 can be arranged in different ways which are shown in FIG. 10 and the changes of magnetic field can activate the water and the porous pebbles 527 provide mineral substances in the water.

While we have shown and described the embodiment in accordance with the present invention, it should be clear to those skilled in the art that further embodiments may be made without departing from the scope of the present invention.

What is claimed is:

1. A water treatment device comprising:
a first filtering member having a first end connected to an inlet pipe and a second end of the first filtering member connected to water gauge, a porous film connected to the first end of the first filtering member, and
a first end of a second filtering member connected to the water gauge, a second end of the second filtering member connected to a first end of a third filtering member, a second end of the third filtering member connected to a first end of a fourth filtering member, a second end of the fourth filter member connected to an outlet pipe, a high density ceramic tank received in the second filtering member and communicating with the second end of the second filtering member, an active carbon cell received in the third filtering member and communicating with the second end of the third filtering member, the fourth filtering member having a plurality of cylinders received therein and arranged to be overlapped along an axis of the fourth filtering member, each cylinder being filled with porous pebbles.

2. The device as claimed in claim 1, wherein each of the cylinders has a tube received therein and a plurality of ribs extend from an inside of the cylinder to be connected to the tube, a plurality of chambers defined between the inside of the cylinder and the tube, each chamber having a magnet received therein and the porous pebbles received in the tube.

3. The device as claimed in claim 2, wherein each of the tube has separation flanges so as to define a plurality of chambers in each of the tubes.
